(19) United States
(12) Patent Application Publication
(10) Pub. No.: US 2025/0190330 A1
(43) Pub. Date: Jun. 12, 2025

(54) SYSTEMS AND METHODS FOR SOFTWARE DEVELOPMENT COLLABORATION

(71) Applicant: WOVEN BY TOYOTA, INC., Tokyo (JP)

(72) Inventors: Thomas HAUTH, Tokyo (JP); Cyril Courtoy, Palo Alto, CA (US)

(73) Assignee: WOVEN BY TOYOTA, INC., Tokyo (JP)

(21) Appl. No.: 18/531,868

(22) Filed: Dec. 7, 2023

(51) Int. Cl. G06F 11/36

(52) U.S. Cl. CPC G06F 11/3668

(57) ABSTRACT

Provided are a method, system, and device for verifying quality assurance on a plurality of software parts. The method may include, executing a quality assurance test on each software part of the plurality of software parts to receive result data; processing the result data for each software part to extract metrics; receiving a quality gate configuration for the software part type, wherein the quality gate configuration comprises at least one metric gate; comparing the metrics for each software part based on the at least one metric gate; and based on the comparison and the quality gate configuration, outputting a result of the build and the metrics

### TECHNICAL FIELD

Systems and methods consistent with example embodiments of the present disclosure relate to managing quality gates for software parts.

### BACKGROUND

In the field of software development, tools such as version control and quality assurance allow multiple collaborating software developers to work together on a software project, which may involve each developer working on individual components. Each individual component may implement a different feature, and may be referred to as a “software part”. Software parts may be dependent on other software parts (i.e., dependencies). When developing a software project, multiple software parts may be developed in parallel in order to allow for faster and more robust development.

In the related art, version control is commonly implemented in a scenario where a developers wishes to create a new version of a software. Branching is commonly used in the related art to implement version control. For example, a main branch may exist which is the current version of the software. In order to create a new version, the developer may create a new branch off of a main branch. This may allow the developer to test the new branch including any new features the new branch may contain. The changes in this new branch may be merged back with the main branch at a later time.

Quality assurance tools may also commonly be used for software development. Such tools may allow a user to evaluate whether a software part achieves certain quality metrics.

In the related art, there may arise a situation where multiple companies or entities in a supply chain are involved, such that the source code for each software part may not be readily available for every developer involved (e.g., there may be software parts which have closed source code). Put in other terms, there may be “boundaries” between different software parts depending on the ownership. Accordingly, it may be difficult for the developer to test whether a software parts with a newer version/branch can function with dependent software parts which has closed source code, that is, what kind of effects the newer software part may have across the entire software part stack (e.g. software parts and their dependencies).

In addition, while the related art may describe the use of quality assurance tools for software development, there is no description of automating and standardizing the use of quality assurance tools across multiple software parts. In particular, there is no method to ensure that all the specified software parts in a project achieve certain quality metrics.

Accordingly, there is a need for version control to manage multiple software parts and their dependencies while also being able to enforce quality standards in a standardized way across the multiple software parts.

### SUMMARY

According to one or more example embodiments, apparatuses and methods are provided for software development collaboration. In particular, software parts (which are individual software components which may each implement different feature(s)) may be used. A method for applying a quality gate to a plurality of software parts of a given type may be provided. In particular, the method may include executing a quality assurance test on each software part of the plurality of software parts to receive result data, processing that result data to extract metrics (e.g., some means of determining the quality of the software part); receiving a quality gate configuration for the given software part type, wherein the quality gate configuration includes a metric gate which can be used to compare the metrics with the requirements specified in the metric gate. Accordingly, the result of the comparison and the metrics themselves can be output to the user. Thus, the quality gate ensures that a standardized quality assurance method is enforced across each software part of the given software part type, and that the user can readily access the result of the quality assurance test with respect to the quality gate.

According to embodiments, a method for verifying quality assurance on a plurality of software parts having a software part type may be provided. The method may include: executing a quality assurance test on each software part of the plurality of software parts to receive result data; processing the result data for each software part to extract metrics; receiving a quality gate configuration for the software part type, wherein the quality gate configuration comprises at least one metric gate; comparing the metrics for each software part based on the at least one metric gate; and based on the comparison and the quality gate configuration, outputting a result of the build and the metrics.

If a comparison of the metrics with the metric gate has a negative result, the result of the build may be an indication that the build failed. If the comparison of the metrics with the metric gate has a positive result, the result of the build may be an indication that the build succeeded.

The quality gate configuration may include: a stage name identifier which may be used to identify the development stage where a quality gate is being enforced; and an enforcement level parameter which may be output as the result of the build if the metric gate has a negative result.

The at least one metric gate may include: a metric name identifier which may be used to identify the type of metric being compared; a threshold parameter comprising a warning threshold value and an error threshold value, wherein if the warning threshold value is met by the comparison, the result of the build includes specifying a warning, and wherein if the error threshold is met by the comparison, the result of the build includes specifying an error, wherein if the result of the build is neither a warning or an error, the result of the build instead includes specifying a success; and a comparison type parameter which indicates how the values of the metrics should be compared with the threshold parameter.

Outputting the result of the build and the metrics may further include: rendering a visualization of the result of the build, wherein if the result includes specifying a warning, a first style is rendered; or if the result includes specifying an error, a second style is rendered, or if it the result instead includes specifying a success, a third style is rendered, wherein the first style, the second style, and the third style are different from each other.

According to example embodiments, a feature branch including a plurality of software parts may be implemented. Software parts may have a hierarchy, wherein a parent software part may have dependent software parts. Apparatuses and methods according to example embodiments may include creating a new feature branch, branching each software part from the parent software part down to the dependent software parts, and merging the feature branch back into the main branch. When each software part is branched, and may be built and published including testing that the software part can be built without errors. Accordingly, a feature branch can be used to test and build the entire software part stack.

According to embodiments, a method for managing a plurality of software parts including at least a first software part may be provided. The method may include: receiving a request to create a feature branch; branching the first software part; building the branched first software part; checking whether the built first software part is successful; wherein if the built first software part is not successful, an error message is sent; wherein if the built first software part is successful, the method further comprises: publishing the built first software part as a first package; searching for dependent software parts of the plurality of software parts which are dependent on the first software part; and branching each dependent software part.

The dependent software parts may include at least a second software part, wherein branching each dependent software part comprises branching the second software part; and wherein the method may further include: updating the dependency of the branched second software part to be on the first package; building the branched second software part; checking whether the built second software part is successful; wherein if the built second software part is not successful, an error message is sent; wherein if the built second software part is successful, the method further comprises: publishing the built second software part as a second package; and checking whether all the dependent software parts were checked successfully.

If all the dependent software parts were checked successfully, the method may further include: rebasing the branched first software part to be on the main branch; merging the branched first software part into a main branch; building the merged first software part; publishing the merged first software part as a first main branch package; and searching for dependent software parts.

The method may further include: rebasing the branched second software part to be on the main branch; updating the dependency of the branched second software part to be on the first main branch package; merging the branched second software part into the main branch; building the merged second software part; and publishing the merged second software part as a second main branch package.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 is a diagram of example components of a device according to an example embodiment;

FIG. 2 is a block diagram of a quality gate configuration file according to one or more example embodiments;

FIG. 3 is a flowchart diagram showing a method for applying a quality assurance test to software parts according to one or more example embodiments;

FIGS. 4A and 4B are flowchart diagrams showing a method for branching and merging feature branches for software parts according to one or more example embodiments; and

FIG. 5 is a flowchart diagram showing an example of creating feature branches with software parts having dependencies according to one or more example embodiments.

### DETAILED DESCRIPTION

The following detailed description of example embodiments refers to the accompanying drawings. The disclosure provides illustration and description, but is not intended to be exhaustive or to limit one or more example embodiments to the precise form disclosed. Modifications and variations are possible in light of the disclosure or may be acquired from practice of one or more example embodiments. Further, one or more features or components of one example embodiment may be incorporated into or combined with another example embodiment (or one or more features of another example embodiment). Additionally, in the flowcharts and descriptions of operations provided herein, it is understood that one or more operations may be omitted, one or more operations may be added, one or more operations may be performed simultaneously (at least in part), and the order of one or more operations may be switched.

It will be apparent that example embodiments of systems and/or methods and/or non-transitory computer readable storage mediums described herein may be implemented in different forms of hardware, firmware, or a combination of hardware and software. The actual specialized control hardware or software code used to implement these systems and/or methods is not limiting of one or more example embodiments. Thus, the operation and behavior of the systems and/or methods and/or non-transitory computer readable storage mediums are described herein without reference to specific software code. It is understood that software and hardware may be designed to implement the systems and/or methods based on the descriptions herein.

Even though particular combinations of features are recited in the claims and/or disclosed in the specification, these combinations are not intended to limit the disclosure of possible example embodiments. In fact, many of these features may be combined in ways not specifically recited in the claims and/or disclosed in the specification. Although each dependent claim listed below may directly depend on only one claim, the disclosure of possible example embodiments includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

The term “software part”, as used herein refers to an individual component or unit of software which may implement one or more feature(s). These software parts may be dependent on other software parts. A plurality of software parts which have the same software part type may also be provided. Specifically, a software part type may indicate what the software part is intended for (e.g., SDK, integration, for system testing, etc.). Each of these software part types may have standards (for example, ISO standards) which need to be passed in order for the software part to pass a specific developmental stage (for example, a coverage stage in which the user is still intending to collect and evaluate code coverage metrics only). These standards may be evaluated in terms of metrics. According to some embodiments, each software part may have an identifier including, but not limited to, a version number and a feature name.

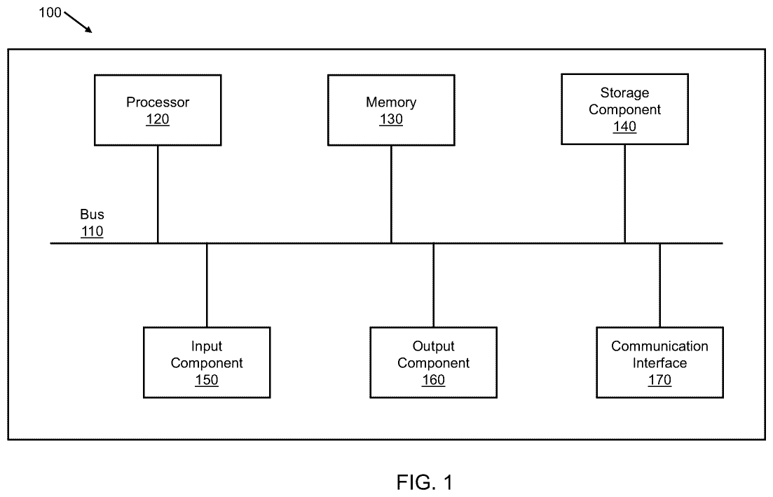

FIG. 1 is a diagram of example components of a software development device 100. As shown in FIG. 1 software development device 100 may include a bus 110, a processor 120, a memory 130, a storage component 140, an input component 150, an output component 160, and a communication interface 170.

Bus 110 includes a component that permits communication among the components of software development device 100. The processor 120 may be implemented in hardware, firmware, or a combination of hardware and software. Processor 120 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In one or more example embodiments, the processor 120 includes one or more processors capable of being programmed to perform a function. The memory 130 includes a random access memory (RAM), a read only memory (ROM), and/or another type of dynamic or static storage device (e.g., a flash memory, a magnetic memory, and/or an optical memory) that stores information and/or instructions for use by the processor 220.

Storage component 140 stores information and/or software related to the operation and use of software development device 100. For example, the storage component 140 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 150 includes a component that permits software development device 100 to receive information, such as via user input (e.g., a touch screen display, a keyboard, a keypad, a mouse, a button, a switch, and/or a microphone). Additionally, or alternatively, input component 150 may include a sensor for sensing information (e.g., a global positioning system (GPS) component, an accelerometer, a gyroscope, and/or an actuator). Output component 160 includes a component that provides output information from software development device 100 (e.g., a display, a speaker, and/or one or more light-emitting diodes (LEDs)).

The communication interface 170 includes a transceiver-like component (e.g., a transceiver and/or a separate receiver and transmitter) that enables software development device 100 to communicate with other devices, such as via a wired connection, a wireless connection, or a combination of wired and wireless connections. The communication interface 170 may permit the software development device 100 to receive information from another device and/or provide information to another device. For example, the communication interface 170 may include, but is not limited to, an Ethernet interface, an optical interface, a coaxial interface, an infrared interface, a radio frequency (RF) interface, a universal serial bus (USB) interface, a Wi-Fi interface, a cellular network interface, or the like.

The software development device 100 may perform one or more example processes described herein. According to one or more example embodiments, the software development device 100 may perform these processes in response to the processor 120 executing software instructions stored by a non-transitory computer-readable medium, such as the memory 130 and/or the storage component 140. A computer-readable medium is defined herein as a non-transitory memory device. A memory device includes memory space within a single physical storage device or memory space spread across multiple physical storage devices.

Software instructions may be read into the memory 130 and/or the storage component 140 from another computer-readable medium or from another device via the communication interface 170. When executed, software instructions stored in the memory 130 and/or the storage component 140 may cause the processor 120 to perform one or more processes described herein.

Additionally, or alternatively, hardwired circuitry may be used in place of, or in combination with, software instructions to perform one or more processes described herein. Thus, one or more example embodiments described herein are not limited to any specific combination of hardware circuitry and software.

The number and arrangement of components shown in FIG. 1 are provided as an example. In practice, the software development device 100 may include additional components, fewer components, different components, or differently arranged components than those shown in FIG. 1. Additionally, or alternatively, a set of components (e.g., one or more components) of the software development device 100 may perform one or more functions described as being performed by another set of components of the software development device 100.

### Quality Gates

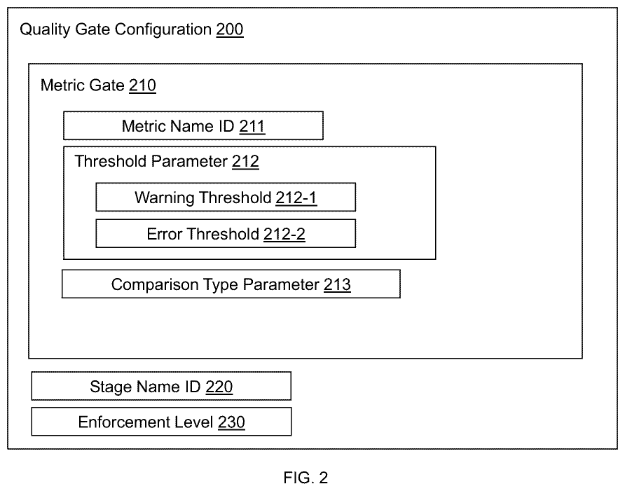

FIG. 2 is a block diagram of a quality gate configuration file 200 according to one or more example embodiments. Quality gate configuration file 200 may include a metric gate 210, a stage name identifier (ID) 220, and an enforcement level parameter 230.

Metric gate 210 may define one or more rules which enforce whether a software part which has been built passes a quality assurance test or not. Metric gate 210 may include a metric name identifier (ID) 211 which may be used to uniquely identify each metric gate, a threshold parameter 212 which may be used to set the specific value(s) for a pass/fail of the quality assurance test, and a comparison type parameter 213 which may be used to set how to compare the result of the quality assurance test with the threshold parameter 212. Threshold parameter 212 may further be defined by a warning threshold value 212-1, which may set the threshold in which a warning result is given, and an error threshold value 212-2, which may set the threshold in which an error result is given.

For example, metric gate 210 may check whether a quality assurance test results in a value of strictly 0.9 or greater for a pass result (e.g., a positive result). If the result is below 0.9, an error may be indicated for the build (e.g., a negative result). If it is well above 0.9, a success may be indicated for the build. If it is just barely 0.9, a warning may be indicated for the build.

In this case, threshold parameter 212 may include a warning threshold value 212-1 of 0.91, and an error threshold value 212-2 of 0.90. A comparison type parameter 213 may be set as “larger”, such that the metric should be to check whether the metric is above the threshold parameter in order to yield a positive (success) result for the build. Nevertheless, it should be appreciated that a variety of methods of comparison may be used in metric gate 210.

Stage name ID 220 may be included in the quality gate configuration file 200, and used to identify the specific developmental stage where a quality gate is being enforced. Different quality gates may be applied at different developmental stages, which may be facilitated by using the stage name identifier. For example, if the stage name ID 220 is “coverage”, the quality gate may only be applied during a code coverage stage. Nevertheless it should be appreciated that any appropriate syntax can be used.

Enforcement level parameter 230 may be used to specify what the output/result of the build should be if the metric gate 210 has a negative result. For example, if it is set to “fail”, the build result may be output as “fail” if the metric gate 210 has a negative result. Nevertheless, it should be noted that the value of the result may not directly be the same as the output in some embodiments, and that the syntax may vary depending on the implementation.

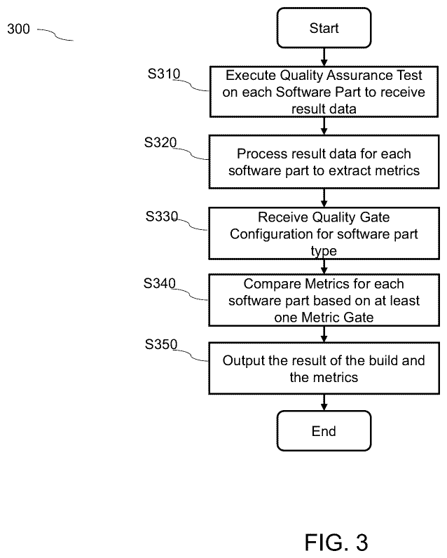

FIG. 3 is a flowchart diagram showing a method 300 for applying a quality assurance test to software parts according to one or more example embodiments. It should be appreciated that a configuration file similar to the quality gate configuration file 200 as illustrated in FIG. 2 may be used.

At operation S310, a quality assurance test may be executed on each software part of a plurality of software parts in order to receive result data. Each software part may have its own software part type. This may be done using any appropriate quality assurance tool as deemed appropriate by the software developer. The results of the quality assurance test may be obtained thereafter.

At operation S320, the results of the quality assurance test may be processed in order to obtain metrics. In particular, since the results of the quality assurance test may not necessarily be in a format which can be readily evaluated as metrics, in some embodiments, the results of the quality assurance test may be processed (for example, parsed) in order to obtain quality metrics.

At operation S330, a quality gate configuration (e.g., quality gate configuration file 200 as illustrated in FIG. 2 and described above), may be obtained for each software part type. This may comprise sending a request to obtain the file, and a response containing the file, according to some embodiments.

At operation S340, the metrics for each software part may be compared using the metric gate (e.g., metric gate 210) from the quality gate configuration file. In particular, a quality gate may be applied, such that the metrics for each software part is compared using a metric gate 210. A negative result for the comparison using the metric gate 210 may be used to output an indication that the build failed, and a positive result for the comparison may be used to output an indication that the build is successful. Nevertheless, it should be appreciated that depending on the configuration of the metric gate 210 (as discussed above), the output with respect to the result may vary. It should be appreciated that although the example discusses using one metric gate 210, a plurality of metric gates may be used depending on the specific implementation.

At operation S350, a result of the build along with the metrics themselves may be output to a user. This may be performed based on the comparison using the metric gate and any additional settings in the quality gate configuration file 200.

According to an embodiment, the output may include some visual aspects (e.g., if the output is into a graphical user interface or dashboard). For example, a user interface (GUI) may provide an overview of the build, the current development stage, and the build status of the software part(s). According to an embodiment, a visualization of the result and the metrics may be rendered. For example, the metrics themselves may be listed in any appropriate format (e.g., a list, a chart, etc.). The result may also have different visual styles depending on what the result was. For example, a “warning”, “success”, “failure” may correspond to different visual styles. According to some embodiments, these visual styles may be different colors (e.g., warning may correspond to yellow, success may correspond to green, failure may correspond to red). In this example, the colors may be used to highlight certain parts of the user interface, or the color of the text may be changed, etc. It should be appreciated that the above example with respect to the user interface is merely an example of how a user interface for utilizing the quality gates can be implemented, and that any appropriate method for visualizing the result and the metrics can be applied.

Based on the above embodiments, by collecting quality metrics from each software part, and enforcing quality gates across each software part, the quality metrics needed for a build to pass can be standardized. Accordingly, standardization of the quality assurance can be achieved.

### Feature Branches

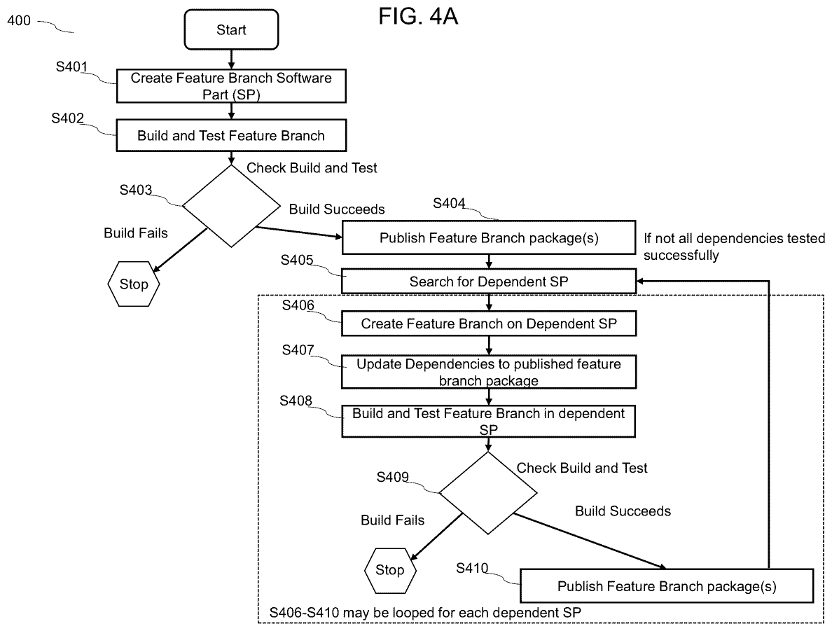

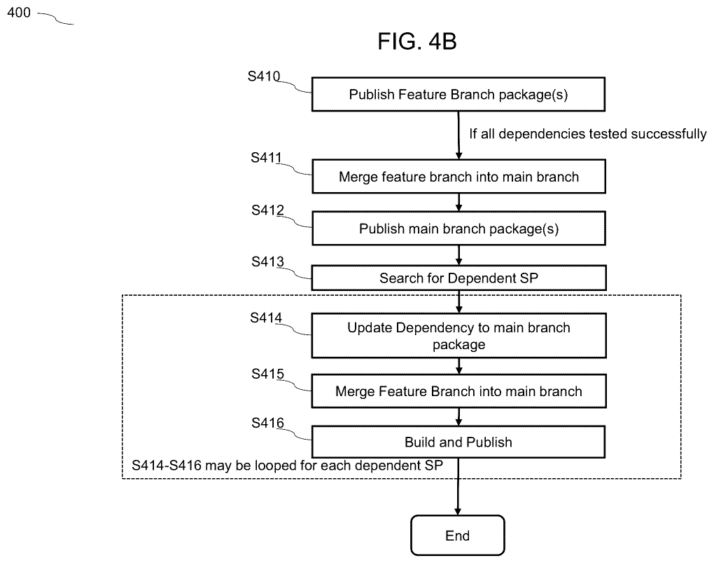

FIGS. 4A and 4B is a flowchart diagram showing a method 400 for branching and merging feature branches for software parts according to one or more example embodiments. Method 400 may be executed when an instruction is received to create a feature branch for a plurality of software parts (SP). This instruction may be initiated by an application developer, according to an embodiment.

Referring to FIG. 4A, at operation S401, a branch of a first software part may be made. In particular, the branch may be made off of a main branch. This step may be performed by an application developer. For example, if the developer provides their changes to the application, they may open a new feature branch using their software development interface.

At operation S402, the branched software part may be built (e.g., compiled), and then subsequently tested. For example, this may include testing such as quality assurance testing, and utilizing method 300 as described with reference to FIG. 3 above. It should be appreciated that this may be automatically performed by continuous integration (CI) automation.

At operation S403, the result of the test may be automatically checked. If the build fails, the entire process may be stopped. According to some embodiments, this may include sending an error message or the like to indicate to the user that the build is not successful. Alternatively, if the build is successful, the process may proceed to publishing the built first software part as a first package at operation S404.

At operation S405, the process may then search for dependent software parts which were dependent on the first software part, and iteratively perform a similar branching process on each of the dependent software parts (e.g., in a loop). In an example embodiment, there may be a second software part which is dependent on the first software part, nevertheless, it should be appreciated that three, four . . . n software parts may be dependent on the first software part.

At operation S406, since a second software part which is dependent on the first software part is found, the second software part may be branched.

At operation S407, the dependency of the branched second software part may be updated to be on the first published package.

At operation S408, a similar building and testing process (similar to operation S402) may be performed on the branched second software part.

At operation S409, a similar checking process (similar to operation S403) may be performed on the branched second software part, wherein only if the second build is successful, the built second software part is published as a second package in operation S410, otherwise the entire process may be stopped. This process of branching the second software part may be repeated (i.e., operations S406-410 may be looped) for all dependent software parts (e.g., a third, fourth, nth software part) upon completing operation S410. Accordingly, the process may check whether or not all dependent software parts were checked/tested successfully, and based on this check, repeat the process above.

It should be appreciated that according to some embodiments, if any modification to the code base is determined to be necessary during the testing/checking process of whether the build is successful, the developer may manually modify the code in the branch and retrigger the build and testing operation thereafter.

Referring to FIG. 4B, at operation S411, after checking that all the dependencies are tested successfully based on the operations as illustrated in FIG. 4A, the feature branch may be merged into the main branch. Specifically, the branched first software part as described with reference to FIG. 4A may be rebased to be on the main branch. The branched first software part may then be merged back onto the main branch. The merged first software part may be built and published thereafter as a first main branch package in operation S412.

In operation S413, after the first main branch package is published, dependent software parts may be searched. In particular, a branched second software part may be rebased to be on the main branch. Subsequently, in operation S414, the dependency of the branched second software part may be updated to be on the first main branch package. The branched second software part may be merged into the main branch, in operation S415 and the merged second software part may subsequently be built and published thereafter as a second main branch package in operation S416. The steps with the second main branch package may be repeated with the rest of the branched dependent software parts (i.e., operations S414-S416 may be looped).

It should be noted that if the feature branch of a software part does not contain any additional changes to the source code, in some embodiments, no additional operation from the developer will be required, and only the version of the dependency of the software part will be updated. In other embodiments, if the rebasing fails due to previous changes on the main branch. The developer may need to manually rebase the feature ranch to fix the conflict

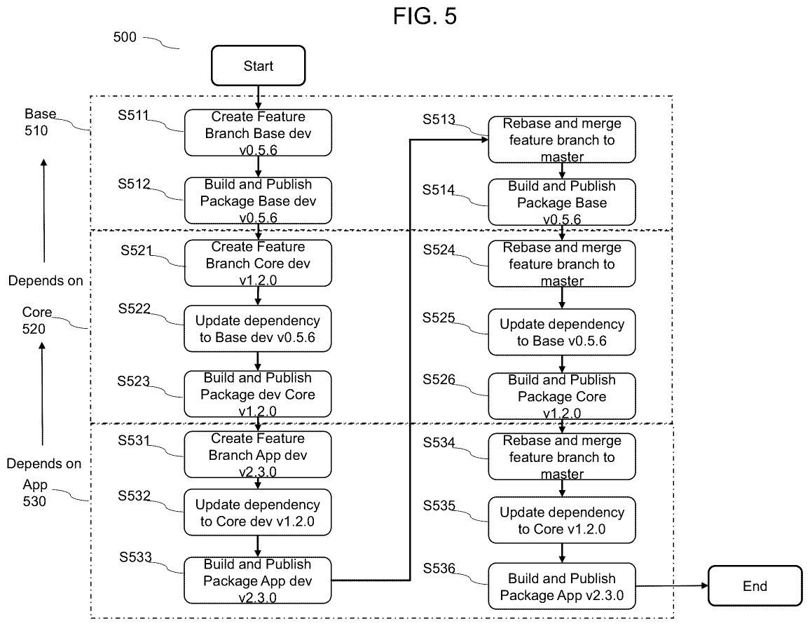

FIG. 5 is a flowchart diagram showing an example method 500 of creating feature branches with software parts having dependencies according to one or more example embodiments.

Referring to FIG. 5, Base 510 is a first software part. Core 520 is a second software part which is dependent on Base 510. App 530 is a third software part which is dependent on Core 520. It should be appreciated that Base 510 may be similar to the first software part described with reference to FIGS. 4A and 4B and Core 520 is a second software part which may be similar to the second software part described with reference to FIGS. 4A and 4B. App 530 may be similar to one of the dependent software parts as mentioned with reference to FIGS. 4A and 4B above.

FIG. 5 illustrates how the branching steps in the left column go from the parent software part down the list of dependencies, starting from Base 510, down to Core 520, and finally App 530. After branching and publishing of the last package App 530 is completed, the merging steps in the right column also go down from the parent software part down the list of dependencies.

Steps described with reference to the branching and merging steps in FIG. 5 may be similar to those specified in FIG. 4A and FIG. 4B. It should also be appreciated that the version numbers and software part names are arbitrarily selected for the example, and any appropriate name and version numbering scheme may be applied.

At operation S511, a feature branch of Base 510 (feature branches in FIG. 5 are denoted by a “dev” version) is created, and subsequently built and published in operation S512.

At operation S521, a feature branch of Core 520 is created.

At operation S522, the dependency of feature branch of Core 520 is updated to be on feature branch of Base 510, and subsequently feature branch of Core 520 is built and published in operation S523

At operation S531, a feature branch of App 530 is created.

At operation S532, the dependency of feature branch of App 530 is updated to be on feature branch of Core 520, and subsequently feature branch of App 530 is built and published in operation S533.

At operation S513, feature branch of Base 510 is rebased, and said feature branch is merged with the master branch. Subsequently, master branch of Base 510 is built and published in operation S514.

At operation S524, feature branch of Core 520 is rebased, and said feature branch is merged with the master branch.

At operation S525, the dependency of master branch of Core 520 is updated to be on master branch of Base 510, and subsequently master branch of Core 520 is built and published in operation S526.

At operation S534, feature branch of App 530 is rebased, and said feature branch is merged with the master branch.

At operation S535, the dependency of master branch of App 530 is updated to be on master branch of Core 520, and subsequently master branch of App 530 is built and published in operation S536.

According to the above example in FIG. 5, a feature branch can be created for multiple software parts and their dependencies, and rebased/merged back into the master branch later.

By branching each software part when creating a feature branch, the overall software part stack can be readily tested, and built, without necessitating direct access to the source code for each of the dependent software parts. Accordingly, even if a dependent software part is closed source, it can still be used in testing the parent software part. Thus, testing can be readily done on a per feature branch basis.

The foregoing disclosure provides illustration and description, but is not intended to be exhaustive or to limit one or more example embodiments to the precise form disclosed. Modifications and variations are possible in light of the disclosure or may be acquired from practice of one or more example embodiments.

One or more example embodiments may relate to a system, a method, and/or a computer readable medium at any possible technical detail level of integration. Further, one or more of the components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In one or more example embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible example embodiments of systems, methods, and computer readable media according to one or more example embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the drawings. In one or more alternative example embodiments, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of one or more example embodiments. Thus, the operation and behavior of the systems and/or methods were described herein without reference to specific software code—it being understood that software and hardware may be designed to implement the systems and/or methods based on the description herein.

What is claimed is:

1. A method for verifying quality assurance on a plurality of software parts having a software part type, the method comprising:
executing a quality assurance test on each software part of the plurality of software parts to receive result data;
processing the result data for each software part to extract metrics;
receiving a quality gate configuration for the software part type, wherein the quality gate configuration comprises at least one metric gate;
comparing the metrics for each software part based on the at least one metric gate; and
based on the comparison and the quality gate configuration, outputting a result of the build and the metrics.

2. The method as claimed in claim 1, wherein if the comparison of the metrics with the metric gate has a negative result, the result of the build is an indication that the build failed.

3. The method as claimed in claim 1, wherein if the comparison of the metrics with the metric gate has a positive result, the result of the build is an indication that the build succeeded.

4. The method as claimed in claim 1, wherein the quality gate configuration comprises:
a stage name identifier which may be used to identify the development stage where a quality gate is being enforced; and
an enforcement level parameter which may be output as the result of the build if the metric gate has a negative result.

5. The method as claimed in claim 1, wherein the at least one metric gate comprises:
a metric name identifier which may be used to identify the type of metric being compared;
a threshold parameter comprising a warning threshold value and an error threshold value, wherein if the warning threshold value is met by the comparison, the result of the build includes specifying a warning, and wherein if the error threshold is met by the comparison, the result of the build includes specifying an error, wherein if the result of the build is neither a warning or an error, the result of the build instead includes specifying a success; and
a comparison type parameter which indicates how the values of the metrics should be compared with the threshold parameter.

6. The method as claimed in claim 5, wherein outputting the result of the build and the metrics further comprises:
rendering a visualization of the result of the build, wherein if the result includes specifying a warning, a first style is rendered; or if the result includes specifying an error, a second style is rendered, or if it the result instead includes specifying a success, a third style is rendered, wherein the first style, the second style, and the third style are different from each other.

7. A method for managing a plurality of software parts including at least a first software part, the method comprising:
receiving a request to create a feature branch;
branching the first software part;
building the branched first software part;
checking whether the built first software part is successful;
wherein if the built first software part is not successful, an error message is sent;
wherein if the built first software part is successful, the method further comprises:
publishing the built first software part as a first package;
searching for dependent software parts of the plurality of software parts which are dependent on the first software part; and
branching each dependent software part.

8. The method as claimed in claim 7, wherein the dependent software parts includes at least a second software part, wherein branching each dependent software part comprises branching the second software part; and wherein the method further comprises:
updating the dependency of the branched second software part to be on the first package;
building the branched second software part;
checking whether the built second software part is successful;
wherein if the built second software part is not successful, an error message is sent;
wherein if the built second software part is successful, the method further comprises:
publishing the built second software part as a second package; and
checking whether all the dependent software parts were checked successfully.

9. The method as claimed in claim 8, wherein if all the dependent software parts were checked successfully, the method further comprises:
rebasing the branched first software part to be on the main branch;
merging the branched first software part into a main branch;
building the merged first software part;
publishing the merged first software part as a first main branch package; and
searching for dependent software parts.

10. The method as claimed in claim 9, wherein the method further comprises:
rebasing the branched second software part to be on the main branch;
updating the dependency of the branched second software part to be on the first main branch package;
merging the branched second software part into the main branch;
building the merged second software part; and
publishing the merged second software part as a second main branch package.

11. An apparatus for verifying quality assurance on a plurality of software parts having a software part type, the apparatus comprising:
at least one memory storing computer-executable instructions; and
at least one processor configured to execute the computer-executable instructions to:
execute a quality assurance test on each software part of the plurality of software parts to receive result data;
process the result data for each software part to extract metrics;
receive a quality gate configuration for the software part type, wherein the quality gate configuration comprises at least one metric gate;
compare the metrics for each software part based on the at least one metric gate; and
based on the comparison and the quality gate configuration, output a result of the build and the metrics.

12. The apparatus as claimed in claim 11, wherein if the comparison of the metrics with the metric gate has a negative result, the result of the build is an indication that the build failed.

13. The apparatus as claimed in claim 11, wherein if the comparison of the metrics with the metric gate has a positive result, the result of the build is an indication that the build succeeded.

14. The apparatus as claimed in claim 11, wherein the quality gate configuration comprises:
a stage name identifier which may be used to identify the development stage where a quality gate is being enforced; and
an enforcement level parameter which may be output as the result of the build if the metric gate has a negative result.

15. The apparatus as claimed in claim 11, wherein the at least one metric gate comprises:
a metric name identifier which may be used to identify the type of metric being compared;
a threshold parameter comprising a warning threshold value and an error threshold value, wherein if the warning threshold value is met by the comparison, the result of the build includes specifying a warning, and wherein if the error threshold is met by the comparison, the result of the build includes specifying an error, wherein if the result of the build is neither a warning or an error, the result of the build instead includes specifying a success; and
a comparison type parameter which indicates how the values of the metrics should be compared with the threshold parameter.

16. The apparatus as claimed in claim 15, wherein the at least one processor is further configured to execute the computer-executable instructions to output the result of the build and the metrics by:
rendering a visualization of the result of the build, wherein if the result includes specifying a warning, a first style is rendered; or if the result includes specifying an error, a second style is rendered, or if it the result instead includes specifying a success, a third style is rendered, wherein the first style, the second style, and the third style are different from each other.

17. An apparatus for managing a plurality of software parts including at least a first software part, the apparatus comprising:
at least one memory storing computer-executable instructions; and
at least one processor configured to execute the computer-executable instructions to:
receive a request to create a feature branch;
branch the first software part;
build the branched first software part;
check whether the built first software part is successful;
wherein if the built first software part is not successful, an error message is sent;
wherein if the built first software part is successful, the method further comprises:
publish the built first software part as a first package;
search for dependent software parts of the plurality of software parts which are dependent on the first software part; and
branch each dependent software part.

18. The apparatus as claimed in claim 17, wherein the dependent software parts includes at least a second software part, wherein branching each dependent software part comprises branching the second software part; and wherein the at least one processor is further configured to execute the computer-executable instructions to:
update the dependency of the branched second software part to be on the first package;
build the branched second software part;
check whether the built second software part is successful;
wherein if the built second software part is not successful, an error message is sent;
wherein if the built second software part is successful, the at least one processor is further configured to execute the computer-executable instructions to:
publish the built second software part as a second package; and
check whether all the dependent software parts were checked successfully.

19. The apparatus as claimed in claim 18, wherein if all the dependent software parts were checked successfully, the at least one processor is further configured to execute the computer-executable instructions to:
rebase the branched first software part to be on the main branch;
merge the branched first software part into a main branch;
build the merged first software part;
publish the merged first software part as a first main branch package; and
search for dependent software parts.

20. The apparatus as claimed in claim 19, wherein the at least one processor is further configured to execute the computer-executable instructions to:
rebase the branched second software part to be on the main branch;
update the dependency of the branched second software part to be on the first main branch package;
merge the branched second software part into the main branch;
build the merged second software part; and
publish the merged second software part as a second main branch package.
